(19) United States
(12) Patent Application Publication
(10) Pub. No.: US 2008/0291019 A1
(43) Pub. Date: Nov. 27, 2008

(54) Remotely Monitorable Electronic Locking Device

(76) Inventors: Micha Auerbach, Maccabin (IL); Noach Eizen, Rishon LeZion (IL); Joseph Shekel, Tel Aviv (IL)

Correspondence Address: ABELMAN, FRAYNE & SCHWAB, 666 THIRD AVENUE, 10TH FLOOR, NEW YORK, NY, 10017, US

(21) Appl. No.: 11/666,978

(22) PCT Filed: Nov. 1, 2005
(86) PCT No.: PCT/IL05/01144

§ 371 Date: Apr. 3, 2008

Related U.S. Application Data
(60) Provisional application No. 60/624,263, filed on Nov. 2, 2004.

(51) Int. Cl. E05B 45/06

(52) U.S. Cl. 340/542

(57) ABSTRACT

A remotely monitorable electronic locking device for use with a device including a conductive loop, the remotely monitorable electronic locking device including a locking element arranged to engage at least one end of the conductive loop, whereby disengagement of the locking element and the end of the conductive loop results in a monitorable event and a wireless communicator associated with the locking element operative to provide a remotely monitorable indication of the monitorable event.

### FIELD OF THE INVENTION

The present invention relates generally to locks and seals, and particularly to a remotely monitorable electronic locking device for use with a security net, mesh, sack of any other package for placing around cargo or assets and the like.

### BACKGROUND OF THE INVENTION

It is essential to protect assets and cargo, freighted by ship, air, rail or truck, from tampering and theft. Valuable cargo passing through freight terminals is prone to attempts by unscrupulous persons to open the cargo and pilfer the contents. Thus, there is a well-established need for simple and efficient apparatus for monitoring cargo and alerting of attempts to tamper with or steal the contents.

### SUMMARY OF THE INVENTION

The present invention seeks to provide simple and efficient apparatus for monitoring assets and alerting of attempts to tamper with or steal the contents.

There is thus provided in accordance with a preferred embodiment of the present invention a remotely monitorable electronic locking device for use with a device including a conductive loop, the remotely monitorable electronic locking device including a locking element arranged to engage at least one end of the conductive loop, whereby disengagement of the locking element and the end of the conductive loop results in a monitorable event and a wireless communicator associated with the locking element operative to provide a remotely monitorable indication of the monitorable event.

Preferably, disruption of the integrity of the conductive loop results in a monitorable event.

### BRIEF DESCRIPTION OF THE DRAWINGS

The present invention will be understood and appreciated more fully from the following detailed description, taken in conjunction with the drawings in which:

FIG. 1 is a simplified illustration of a remote monitoring locking device for use with an electronic filament netting or packaging material integrally formed with an electronic filament netting, constructed and operative in accordance with a preferred embodiment of the present invention;

FIGS. 2A and 2B are simplified illustrations of a remote monitoring locking device for use with a storage envelope or package, constructed and operative in accordance with another preferred embodiment of the present invention; and

FIG. 3 is a simplified illustration of the remote monitoring locking device of FIGS. 1-2B.

### DETAILED DESCRIPTION OF PREFERRED EMBODIMENTS

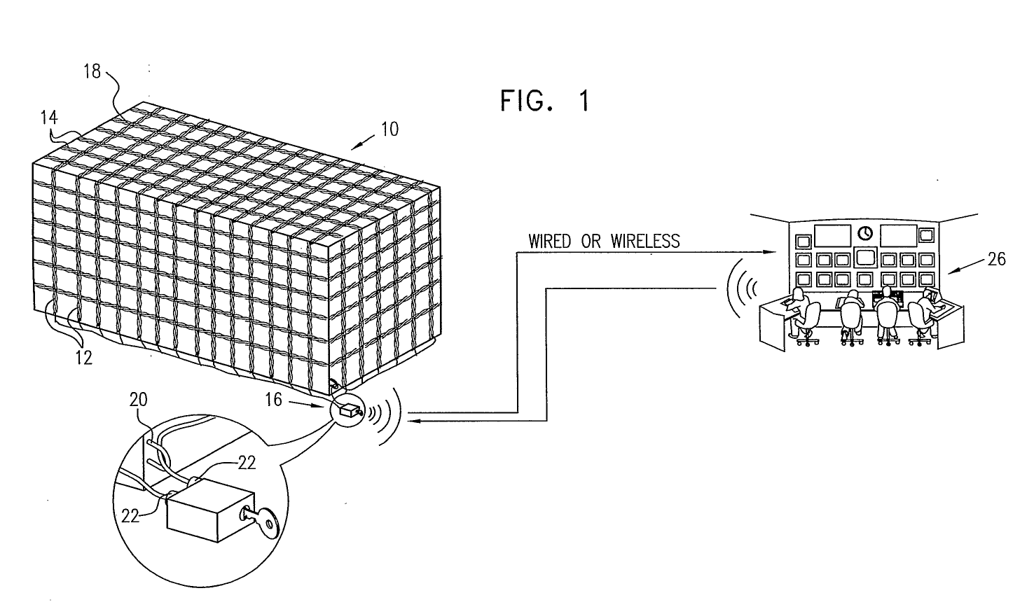

Reference is now made to FIG. 1, which is a simplified illustration of a remote monitoring locking device for use with an electronic filament netting. As seen in FIG. 1, an electronic filament netting 10, preferably including a warp of a first plurality of wires 12 woven together with a weft of a second plurality of wires 14, is electrically connected to a remotely monitorable electronic locking device 16. Netting 10, comprising wires 12 and 14, is preferably constructed in accordance with the teachings of U.S. Pat. No. 6,144,298, the disclosure of which is incorporated herein by reference.

As shown in FIG. 1, netting 10 may be draped over an object 18 to be protected, or alternatively, may be embedded in a material, such as a cloth or tarpaulin, suitable for draping over object 18. After placing netting 10 over the object 18, one of the connective ends of netting 10 is preferably passed through a loop 20 to secure the netting to object 18. The connective ends of netting 10 are then preferably inserted into terminals 22 of remotely monitorable electronic locking device 16.

Remotely monitorable electronic locking device 16 preferably communicates with a remote monitoring station, such as a station 26, preferably via a two-way wired or wireless communication link, such as an active RF link or other suitable communication link. Suitable controllers may be provided for remotely controlling any portion of remotely monitorable electronic locking device 16.

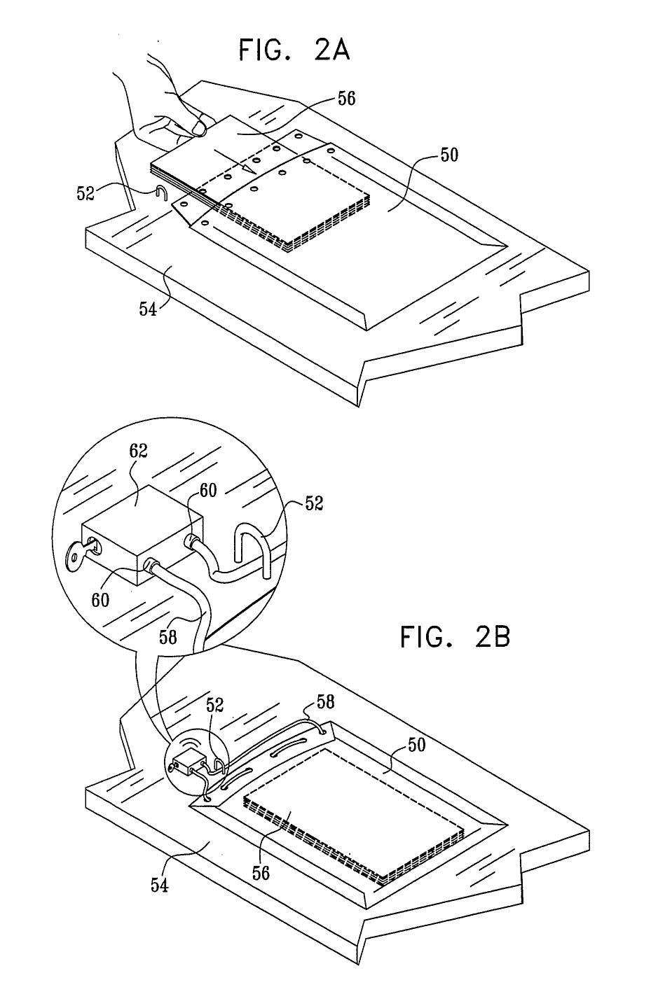

Reference is now made to FIGS. 2A and 2B, which is a simplified illustration of a remote monitoring locking device for use with a storage envelope or package, such as for storing sensitive documents. As seen in FIGS. 2A and 2B, a storage envelope 50 is positioned proximate to a loop 52 defining a storage location, such as on a shelf 54. Documents 56 are then inserted into storage envelope 50, which is then sealed with a sealing wire 58 passed therethrough. After passing sealing wire 58 through storage envelope 50, one of the connective ends of sealing wire 58 is preferably passed through loop 52 to secure the netting to shelf 54. The connective ends of sealing wire 58 are then preferably inserted into terminals 60 of a remotely monitorable electronic locking device 62.

Remotely monitorable electronic locking device 62 preferably communicates with a remote monitoring station, such as station 26 (FIG. 1), preferably via a two-way wired or wireless communication link, such as an active RF link or other suitable communication link. Suitable controllers may be provided for remotely controlling any portion of remotely monitorable electronic locking device 62.

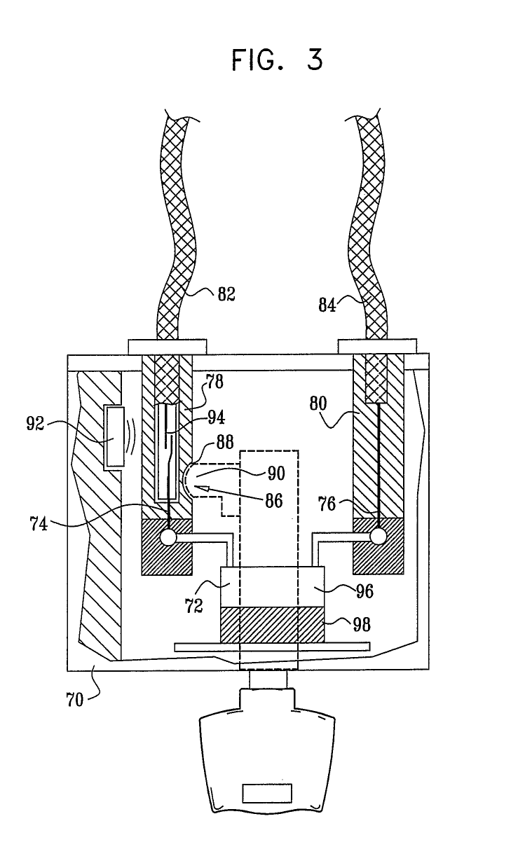

Reference is now made to FIG. 3, which is a simplified illustration of the remotely monitorable electronic locking device, such as locking device 16 of FIG. 1 or locking device 62 of FIG. 2B. As seen in FIG. 3, a remotely monitorable electronic locking device 70 preferably includes a sensing circuitry and transceiver portion 72 electrically connected, typically via wires 74 and 76, with connectors 78 and 80 of cables 82 and 84, such as connective ends of net 10 of FIG. 1 or connective ends of sealing wire 58 of FIG. 2. At least one of connectors 78 and 80 preferably includes a lockable tip 86, preferably formed with an undercut groove 88, which is adapted for lockable engagement with a corresponding locking element 90 forming part of locking device 70. Locking device 70 also defines a socket, which includes a magnet 92. Locking device 70 is here shown to include a key-operated lock, it being appreciated that any other suitable type of lock may be employed. It is appreciated that locking device 70 is preferably lockable by means of a mechanical key. The locking engagement between connector 78 and locking element 90 is preferably such that without first unlocking the lock, it is impossible to remove connector 78 from engagement with the locking element 90.

At least one of connectors 78 and 80 preferably includes a series connected reed switch 94 which is closed by magnet 92 when connector 78 is in lockable engagement with locking element 90.

In accordance with a preferred embodiment of the present invention, sensing circuitry and transceiver portion 72 includes sensing circuitry 96 and an RF transceiver 98. Sensing circuitry 96 is electrically coupled to connectors 78 and 80 and senses the integrity of a conductive loop which is defined by a device connected to connectors 78 and 80, such as net 10 of FIG. 1 or sealing wire 58 of FIG. 2, when the connector 78 is in lockable engagement with locking element 90.

Receiving an output from sensing circuitry 96 is transceiver 98, which is operative to provide transmitted information indicating whether the conductive loop is intact.

In accordance with a preferred embodiment of the present invention, transceiver 98 is operative to transmit status of the conductive loop at a selectable, preset interval to a remote monitoring station, such as a station 26 of FIG. 1.

Conventional wireless monitoring circuitry (not shown) may be employed to receive information which is transmitted by RF transceiver 98 and indicates when the connector 78 is located in lockable engagement with locking element 90 and when the connector 78 is separated from locking element 90 due to disengagement of connector 78 and locking element 90 by using a key to unlock locking element 90. It is appreciated that the provision of reed switch 94 and magnet 92 enables sensing circuitry 96 to sense when the connector 78 is located in lockable engagement with locking element 90 and also enables sensing circuitry 96 to sense when the integrity of the conductive loop has been altered, such as by tampering.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A remotely monitorable electronic locking device for use with a device including a conductive loop, said remotely monitorable electronic locking device comprising:
a locking element arranged to engage at least one end of said conductive loop, whereby disengagement of said locking element and said end of said conductive loop results in a monitorable event; and
a wireless communicator associated with said locking element operative to provide a remotely monitorable indication of said monitorable event.

2. A remotely monitorable electronic locking device according to claim 1 and wherein disruption of the integrity of said conductive loop results in a monitorable event.
